(19) United States
(12) Patent Application Publication
(10) Pub. No.: US 2003/0077204 A1
(43) Pub. Date: Apr. 24, 2003

(54) Micro-globule metering and sampling structure and microchips having the structure

(76) Inventors: Minoru Seki, Tokyo (JP); Masumi Yamada, Saitama (JP); Hisashi Hagiwara, Tokyo (JP)

Correspondence Address: MATTINGLY, STANGER & MALUR, P.C., Suite 370, 1800 Diagonal Road, Alexandria, VA, 22314, US

(21) Appl. No.: 10/270,517

(22) Filed: Oct. 16, 2002

(30) Foreign Application Priority Data
Oct. 18, 2001 (JP) 2001-320592
Sep. 25, 2002 (JP) 2002-278924

(51) Int. Cl. G01N 30/02; B01L 3/00

(52) U.S. Cl. 422/70; 422/100

(57) ABSTRACT

An improved structure has a first channel and a-second channel that extend in specified directions, a third channel open in a wall of said first channel and a fourth channel that is open to a wall of said second channel such that it couples an end of said third channel to said second channel, that has a property of being less wettable (or insensitive to capillary attraction) and that is narrower than the other three channels; a liquid introduced into said first channel is drawn into said third channel and thereafter said liquid that remains in said first channel is removed to meter and sample a volume of globule equal to the capacity of said third channel. If the second channel is already filled with a liquid, the structure is modified to further include a fifth channel that is open to a wall of said fourth channel, that is narrower than or equal in thickness to said fourth channel and that is made of a wall having a property of being less wettable (or insensitive to capillary attraction).

### BACKGROUND OF THE INVENTION

This invention relates to a structure for metering and sampling very small amounts of globules. More specifically, the invention relates to such a micro-globule metering and sampling structure suitable for use in performing analysis, chemical reaction, etc. using a variety of samples. The invention also relates to microchips having said structure within a substrate.

There have heretofore been known a variety of apparatuses for performing analysis by electrophoresis, chromatography, etc. In order to provide accurate results of analysis by these apparatuses, globules of a sample and the like to be used must be metered and sampled quantitatively.

Accordingly, various techniques have been proposed to ensure that globules of a sample and the like are metered and sampled quantitatively in the variety of apparatuses used in electrophoresis, chromatography, etc. See, for example, Japanese Patent Laid-Open No. 148628/1998 (in particular, FIGS. 1 and 2) which describes an electrophoretic apparatus in microchip form. Also see Japanese Patent Laid-Open No. 198680/1995 (in particular, FIGS. 1 and 2) which describes an apparatus and method for separating a mixture of fluid substances by electrophoresis. However, each of these prior art methods must use more than necessary amounts of the sample to be analyzed and, hence, it has been impossible to reduce the dead volume of the sample.

Microchips are also used to perform chemical reactions and analyses employing globules of a sample and the like in very small amounts. Again, in order to obtain accurate results with the microchip, globules of the sample and the like to be used must be metered and sampled quantitatively. In fact, however, the volume of the globules to be handled in microchip assay is so small that they are difficult to meter and sample quantitatively; as a result, various complex designs are required but then they must be operated by cumbersome procedures.

### SUMMARY OF THE INVENTION

An object, therefore, of the present invention is to provide a micro-globule metering and sampling structure which is simple in structure and requires only simple procedures to achieve quantitative metering and sampling of very small amounts of globules.

Another object of the invention is to provide a micro-globule metering and sampling structure which, when used in a variety of apparatuses that require quantitative handling of globules, can reduce the dead volume of the sample while saving the installation space and cost of the overall apparatus.

These objects of the invention can be attained by the micro-globule metering and sampling structure of the invention which, being based on the surface tension of liquids, has been accomplished by taking advantage of the capillarity (capillary repulsion) a liquid exerts on a channel or a fluid passage.

According to a first embodiment of the invention, there is provided a micro-globule metering and sampling structure having a first channel and a second channel that extend in specified directions, a third channel open to a wall of said first channel and a fourth channel that is open to a wall of said second channel such that it couples an end of said third channel to said second channel, that has a property of being less wettable (or insensitive to capillary attraction) and that is narrower than the other three channels, wherein a liquid introduced into said first channel is drawn into said third channel via the opening of said third channel which is open in a wall of said first channel and thereafter said liquid that remains in said first channel is removed to meter and sample a volume of globule equal to the capacity of said third channel.

According to a second embodiment of the invention, there is provided a micro-globule metering and sampling structure having at least two systems each having a first channel and a second channel that extend in specified directions, a third channel open to a wall of said first channel and a fourth channel that is open to a wall of said second channel such that it couples an end of said third channel to said second channel, that has a property of being less wettable (or insensitive to capillary attraction) and that is narrower than the other three channels, wherein a liquid introduced into said first channel is drawn into said third channel via the opening of said third channel which is open in a wall of said first channel and thereafter said liquid that remains in said first channel is removed to meter and sample a volume of globule equal to the capacity of said third channel, said at least two systems sharing said first channel or said second channel.

According to a third embodiment of the invention, there is provided a micro-globule metering and sampling structure in which two or more of said fourth channels are connected to said third channel or, alternatively, said fourth channel has two or more branches.

According to a fourth embodiment of the invention, there is provided a micro-globule metering and sampling structure which has more than one set of said third channel and the fourth channel connected to it.

According to a fifth embodiment of the invention, there is provided a micro-globule metering and sampling structure which further has a fifth channel that is open to a wall of said fourth channel, that is narrower than or equal in thickness to said fourth channel and that is made of a wall having a property of being less wettable (or insensitive to capillary attraction).

According to a sixth embodiment of the invention, there is provided a micro-globule metering and sampling structure which further has means by which the globule that has been metered and sampled in a volume equal to the capacity of said third channel is allowed to flow into said second channel via said fourth channel.

According to a seventh embodiment of the invention, there is provided a micro-globule metering and sampling structure which further has means by which the globule that has been metered and sampled in a volume equal to the capacity of said third channel is allowed to flow into said second channel via said fourth channel when said second channel is filled with a liquid up to the area which is near the opening of said fourth channel.

According to an eighth embodiment of the invention, there is provided a micro-globule metering and sampling structure, wherein said first channel, said second channel, said third channel, said fourth channel and said fifth channel are each formed in a substrate.

### BRIEF DESCRIPTION OF THE DRAWINGS

FIGS. 1A-1C illustrate the principle of the invention in conceptual form, in which FIG. 1A shows the micro-globule metering and sampling structure and FIGS. 1B and 1C show the method of metering and sampling a globule;

FIGS. 1A-1C illustrate a micro-globule metering and sampling structure having two globule forming systems as set forth in claim 2, wherein FIG. 2A refers to the case where the two systems share channel A and FIG. 2B refers to the case of sharing channel B;

FIGS. 3A and 3B illustrate micro-globule metering and sampling structures as set forth in claims 3 and 4, respectively, wherein FIG. 3A refers to the case where channel D diverges into three sub-channels and FIG. 3B refers to the case of providing three sets of channels C and D of different thicknesses;

FIGS. 4A-4D illustrate a micro-globule metering and sampling structure as set forth in claim 5, wherein FIG. 4A shows its details and FIGS. 4B-4D show the method of introducing a globule into channel B which is filled with a liquid;

FIGS. 5A, 5B, 5C1 and 5C2 illustrate a microchip for use in capillary chromatography having the micro-globule metering and sampling structure of the invention, wherein FIG. 5A shows a general layout of the chip, FIG. 5B shows enlarged the area in which a very small amount of sample is introduced and determined quantitatively, and FIGS. 5C1 and 5C2 are sections C-C of FIG. 5B;

FIG. 6A is a plan view of a microchip 24 employing the micro-globule metering and sampling structure according to another embodiment of the invention;

FIG. 6B is an enlarged plan view of area B in FIG. 6A; and

FIG. 6C is an enlarged plan view of area C in FIG. 6B.

### DETAILED DESCRIPTION OF THE INVENTION

Modes for carrying out the present invention as it relates to a micro-globule metering and sampling structure are described below in detail with reference to the accompanying drawings.

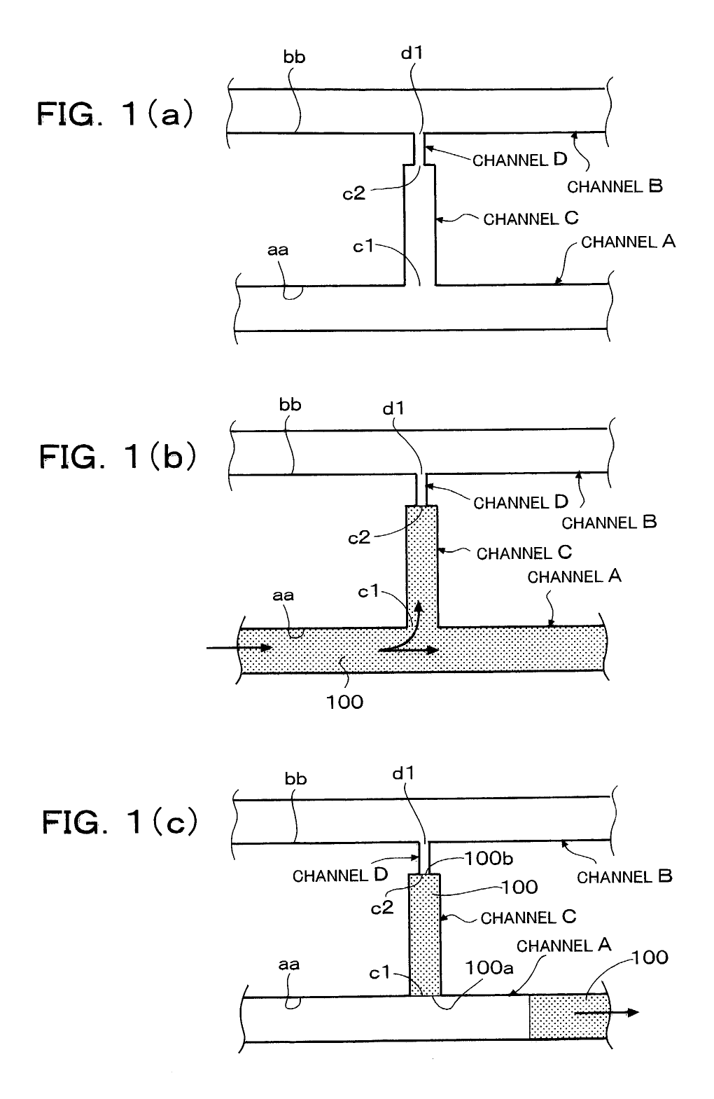

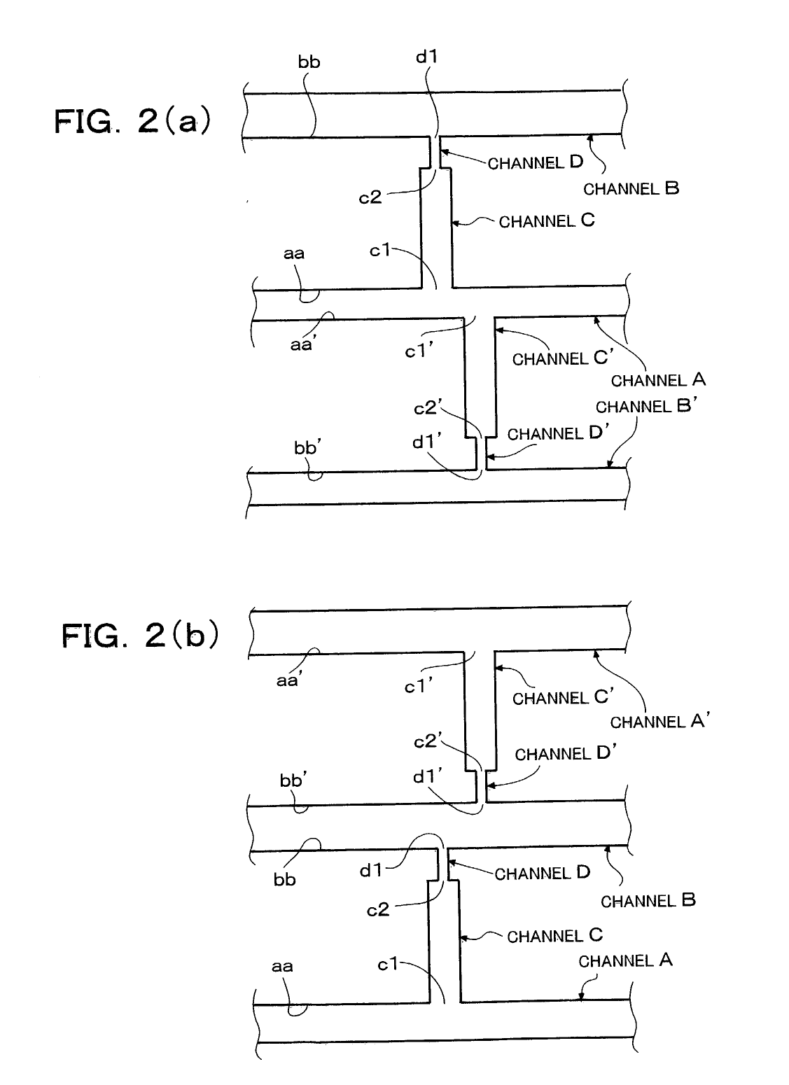

FIGS. 1A-1C illustrate the principle of the invention in conceptual form. Four channels, A (first channel), B (second channel), C (third channel) and D (fourth channel), are formed in such a way that channels C and C are cascaded in series between channels A and B, with channel C being followed by channel D in the direction of liquid flow. A liquid is first introduced into channel C via channel A. Channel D having a wall that is less wettable (or insensitive to capillary attraction) is narrower than the other channels, so a greater force is required to introduce the liquid into channel D; by exerting an appropriate pressure on it, the liquid can be allowed to stop at the interface c2 between channels C and D (see FIGS. 1A and 1B).

More specifically, when a liquid 100 is introduced into channel A (as hatched in FIG. 1B), it can be further introduced into the narrower channel C via an opening cl that is open in a wall aa of channel A. If channels A and C have wettable walls, channel C may be made narrower than channel A and this ensures that liquid 100 is spontaneously drawn into channel C via opening cl under the action of stronger capillary attraction. If channels A and C have less wettable walls, liquid 100 can be introduced into channel C by exerting an appropriate pressure from an end of channel A (see FIG. 1B).

Liquid 100 that has reached the other end c2 of channel C which connects to channel D ending at dl is blocked by the capillary repulsion of channel D having a less wettable wall and will not get into channel D. This is also true in the case where channel C has a less wettable wall because it develops a greater capillary repulsion than channel D (see FIG. 1B).

Subsequently, residual liquid 100 in channel A is removed by, for example, creating a sufficient pressure difference across channel A that it moves toward the lower pressure side (see FIG. 1C). On this occasion, liquid 100 in channel C will not usually return into channel A (see FIG. 1C). As a result, two end faces 100a and 100b of the liquid 100 in channel C come into alignment with the opening cl of channel C and the end c2 at which it connects to channel D, making it possible to meter and sample a volume of globule equal to the capacity of channel C between c1 and c2 (see FIG. 1C).

The globule formed within channel C can be easily introduced into channel B via channel D and its opening dl by, for example, creating a sufficient pressure difference between channels A and B that the pressure in the former is slightly higher than in the latter. As a result, the globule can be used for the purpose of reaction or analysis by, for example, pneumatic transfer.

While various types of micro-globule metering and sampling structure are provided by the invention, the one set forth in claim 1 has a first channel (channel A) and a second channel (channel B) that extend in specified directions, a third channel (channel C) open to a wall of said first channel and a fourth channel (channel D) that is open to a wall of said second channel (channel B) such that it couples an end of said third channel (channel c) to said second channel (channel B), that has a property of being less wettable (or insensitive to capillary attraction) and that is narrower than the other three channels, wherein a liquid introduced into said first channel is drawn into said third channel via the opening of said third channel which is open in a wall of said first channel and thereafter said liquid that remains in said first channel is removed to meter and sample a volume of globule equal to the capacity of said third channel.

Therefore, according to the structure set forth in claim 1, a globule of a volume equal to the capacity of the third channel can be formed by introducing a liquid from the first channel into the third channel. The structure is simple in structure and requires only simple procedures to achieve quantitative metering and sampling of globules. In addition, the structure can reduce the dead volume of the sample while saving the installation space and cost of the overall apparatus.

The micro-globule metering and sampling structure set forth in claim 2 of the invention has at least two systems each having a first channel (channel A) and a second channel (channel B) that extend in specified directions, a third channel (channel c) open to a wall of said first channel and a fourth channel (channel D) that is open to a wall of said second channel (channel B) such that it couples an end of said third channel (channel C) to said second channel (channel B), that has a property of being less wettable (or insensitive to capillary attraction) and that is narrower than the other three channels, wherein a liquid introduced into said first channel is drawn into said third channel via the opening of said third channel which is open in a wall of said first channel and thereafter said liquid that remains in said first channel is removed to meter and sample a volume of globule equal to the capacity of said third channel, said at least two systems sharing said first channel or said second channel (see FIGS. 2A and 2B).

As just described above, the two systems in the structure set forth in claim 2 share the first or second channel. If a plurality of globules of the same kind are quantitatively metered and sampled in each of the two systems sharing the first channel, globules of different kinds that have been metered and sampled in the two systems may be combined, diluted by combining, reacted by combining, subjected to analysis by reaction after combining, etc. in the second channels in the respective systems with globules of different kinds that have been metered and sampled in the respective systems (see FIG. 2A). On the other hand, if globules of different kinds are quantitatively metered and sampled in the two systems sharing the second channel, the prepared globules of different kinds may be combined, diluted by combining, reacted by combining, subjected to analysis by reaction after combining, etc. in the second channel common to the two systems (see FIG. 2B).

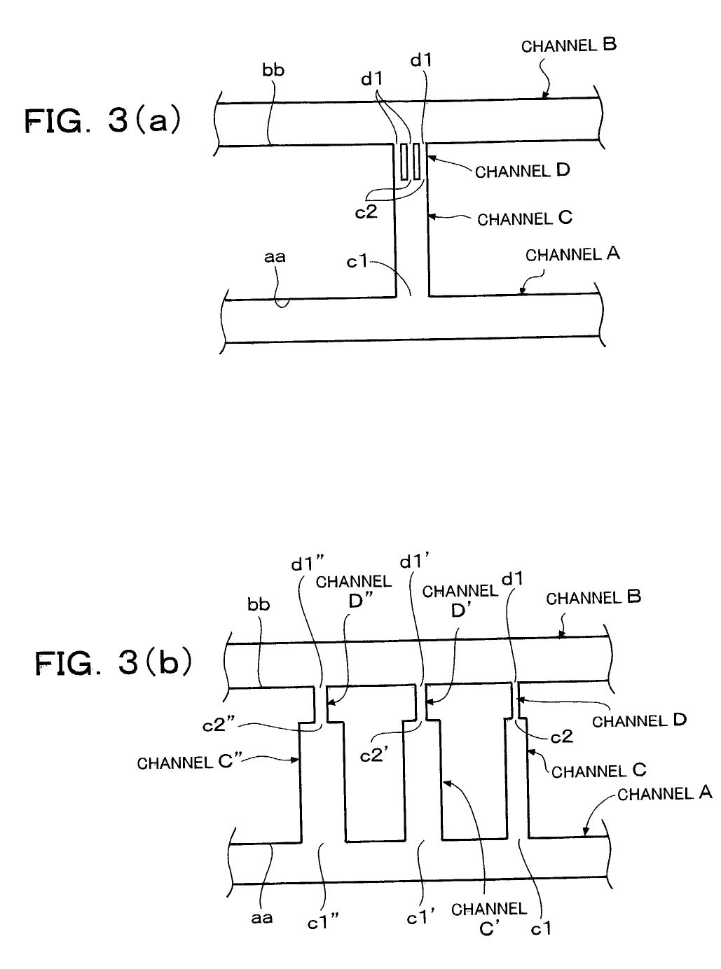

As set forth in claim 3, the micro-globule metering and sampling structure according to claim 1 or 2 may be so modified that two or more of the fourth channels (channel D) are connected to the third channel (channel C) or, alternatively, the fourth channel (channel D) has two or more branches (see FIG. 3A). If this design is adopted, the velocity of the fluid in channel D can be adjusted independently of capillary repulsion.

As set forth in claim 4, the micro-globule metering and sampling structure according to any one of claims 1-3 may be so modified that more than one set of the third channel (channel C) and the fourth channel (channel D) are formed (see FIG. 3B). If this design is adopted, plural sets of the third and fourth channels (channel C/channel D, channel C′/channel D′ and channel C″/channel D″ in FIG. 3B) allow a plurality of globules of different volumes to be metered and sampled in a quantitative and parallel manner.

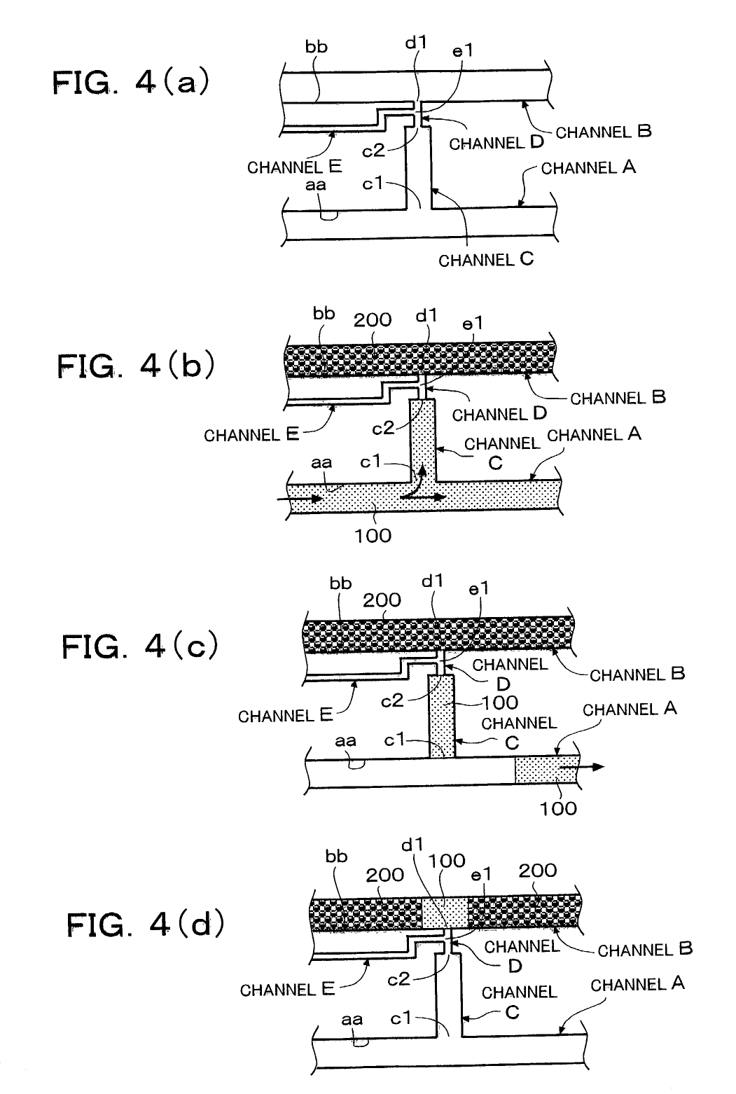

As set forth in claim 5, the micro-globule metering and sampling structure according to any one of claims 1-4 may be so modified that it further has a fifth channel (channel E) that is open to a wall of said fourth channel (channel D), that is narrower than or equal in thickness to said fourth channel and that is made of a wall having a property of being less wettable (or insensitive to capillary attraction) (see FIG. 4).

FIG. 4 illustrates in conceptual form the principle of the micro-globule metering and sampling structure set forth in claim 5. As shown in FIG. 4A, five channels, channel A, channel B, channel C, channel D and channel E, are provided in such a way that channels C and D are cascaded in series between channels A and B, with channel E having an opening e1 in a wall of channel D. Channel D has a wall having a property of being less wettable (or insensitive to capillary attraction), so if a liquid is introduced from channel A into channel C, it stops at the interface c2 between channels C and D and cannot be introduced into channel D without exerting a greater force.

When a liquid 100 is introduced into the wide channel A (as hatched in FIG. 4B), it can be further drawn into narrower channel C via an opening cl that is open in a wall aa of channel A (see FIG. 4B) If channel B is not filled with the liquid up to the area near the opening dl of channel D, the above-described phenomenon is the same as what takes place in the structure according to any one of claims 1-4. However, in the case where a liquid 200 has been preliminarily introduced into channel B (as shaded in FIG. 4B), liquid 100 is introduced into channel C only incompletely in the structure according to any one of claims 1-4. This failure to achieve complete introduction of liquid 100 into channel C can be explained by the absence of any route for the escape of the residual gas in channel C.

Assume here that in the structure set forth in claim 5, liquid 200 has already been introduced into channel B (as shaded in FIG. 4B). As liquid 100 is introduced into channel C, any gas that exits in the channel is purged into channel E (which is open to the atmosphere at the end opposite to the opening e1) (see FIG. 4B). In this case, too, liquid 100 that has reached the other end c2 of channel C at the interface with channel D is blocked by the capillary repulsion of channel D (the zone between c2 and dl) having a less wettable wall (or a wall insensitive to capillary attraction) and will not get into channel D (see FIG. 4B).

Subsequently, the residual liquid 100 in channel A is removed by, for example, creating a sufficient pressure difference across channel A that it moves toward the lower pressure side. As a result, a volume of globule equal to the capacity of channel C (the zone between c1 and c2) can be metered and sampled (see FIG. 4C).

The globule formed within channel C can be introduced into the liquid 200 in channel B via channel D by, for example, creating a sufficient pressure difference between channels A and B that the pressure in the former is slightly higher than in the latter. On this occasion, the end of channel E which is opposite the end e1 must be closed (see FIG. 4D).

Thus, by using the structure set forth in claim 5, one can offer a practically feasible technique by which very small amounts of samples or reaction reagents can be quantitatively introduced into a variety of analyzers or reactors for use in electrophoresis, chromatography, etc.

As set forth in claim 6, the micro-globule metering and sampling structure according to any one of claims 1-5 may be so modified that it further has means by which the globule that has been metered and sampled quantitatively in said third channel (channel C) is allowed to flow into said second channel (channel B) via said fourth channel (channel D) from its opening which is open in a wall of said second channel (channel B).

Stated specifically, in order to ensure that the globule formed quantitatively in the third channel will flow into the second channel, the pressure in the first channel may be adjusted to be slightly higher than the pressure in the second channel by, for example, creating a sufficient pressure difference between the two channels or applying a centrifugal force in the direction in which the globule is to flow out. As the means for creating a sufficient pressure difference, a known conventional pressurizing or evacuating mechanism may be employed with advantage.

Thus, by using the structure set forth in claim 6, the quantitatively metered and sampled globule in the third channel can be flowed into the second channel and very small amounts of samples or reaction reagents can be quantitatively introduced into a variety of analyzers or reactors for use in electrophoresis, chromatography, etc.

As set forth in claim 7, the micro-globule metering and sampling structure according to claim 6 may be so modified that it further has means by which the globule that has been metered and sampled quantitatively in said third channel (channel C) is allowed to flow into said second channel (channel B) via said fourth channel (channel D) from the opening of said third channel which is open in a wall of said second channel when said second channel is filled with a liquid.

Stated specifically, according to the invention set forth in claim 7, the globule formed quantitatively within the third channel using the structure set forth in claim 5 can be flowed into the second channel by, for example, creating a sufficient pressure difference between the first and second channels or applying a centrifugal force in the direction in which the globule is to flow out, with the end of channel E opposite e1 being closed, so that the pressure in the first channel becomes slightly higher than the pressure in the second channel.

Thus, by using the structure set forth in claim 7, the quantitatively metered and sampled globule in the third channel can be flowed into the second channel and very small amounts of samples or reaction reagents can be quantitatively introduced into a variety of analyzers or reactors for use in electrophoresis, chromatography, etc. The micro-globule metering and sampling structure of the invention can be adapted to various operations including sample injection in electrophoresis of nucleic acids and proteins, and many other processes such as protein synthesis or separation and the synthesis and screening of chemical substances after rendering the surfaces or any other desirable areas of channels more wettable or less wettable or after performing the necessary treatments that are compatible with the surface properties of proteins and DNA.

As set forth in claim 8, the micro-globule metering and sampling structure according to any one of claims 1-7 may be so modified that said first channel (channel A), said second channel (channel B), said third channel (channel C), said fourth channel (channel D) and said fifth channel (channel E) are each formed in a substrate.

Thus, the structure set forth in claim 8 is simple in structure and requires only simple procedures to achieve quantitative metering and sampling of globules in very small volumes; in addition, the structure can achieve further reduction in the dead volume of the sample, as well as in the installation space and cost of the overall apparatus.

As set forth in claim 9, the micro-globule metering and sampling structure according to any one of claims 1-8 may be so modified that said third channel is formed to have a capacity in the range of the picoliter to microliter order.

Thus, the structure set forth in claim 8 is simple in structure and requires only simple procedures to achieve quantitative metering and sampling of globules in very small volumes ranging from the picoliter to microliter order.

### EXAMPLE 1

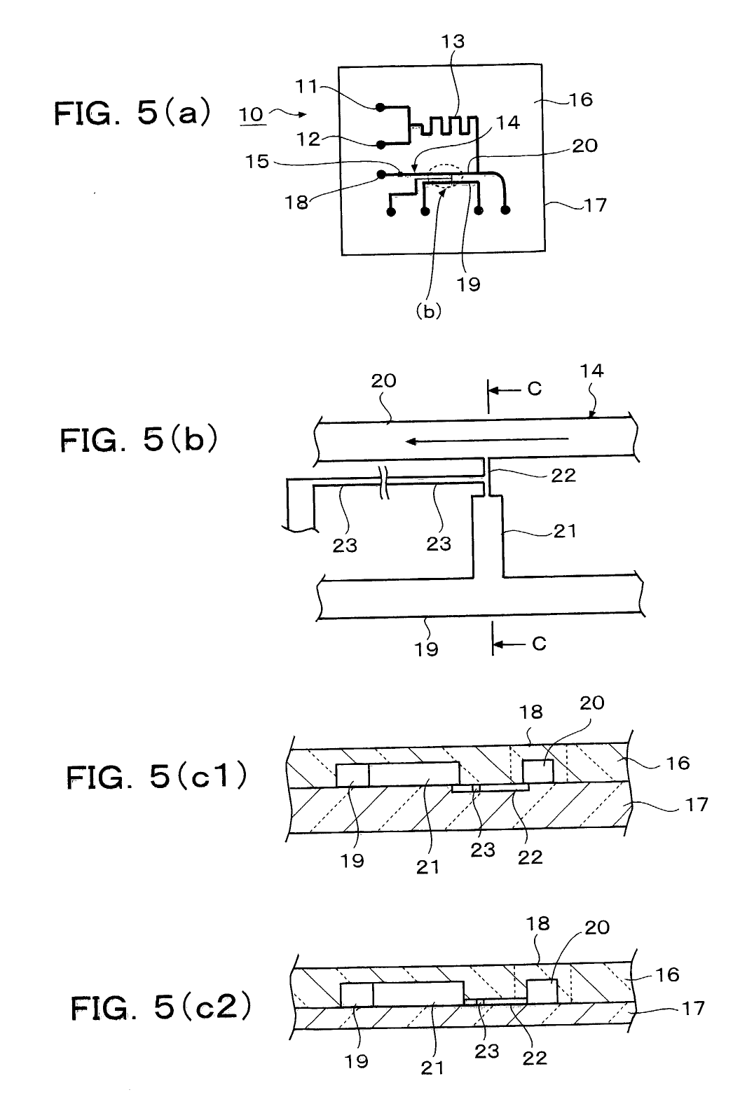

FIG. 5A shows a microchip having the micro-globule metering and sampling structure of the invention. The microchip generally indicated by 10 in FIG. 5A is intended to perform capillary ion-exchange chromatography in protein analysis and has the micro-globule metering and sampling structure of the invention in the sample injecting portion.

Referring further to FIG. 5A, ports 11 and 12 are intended for introducing protein eluting buffers. Buffers of different ionic strengths as introduced at these two ports are flowed in varying quantities and mixed in a mixer 13 to form a gradient of ionic strength. Having this function, each of the ports 11 and 12 is open to the atmosphere at the top but communicates to channels at the bottom.

A microchannel 14 is a chromatographic column and packed with ion-exchange beads in a 3-mm zone between a bead blockade 15 and the micro-globule metering and sampling structure (b). Located at the far end of the microchannel 14 which is away from the bead blockade 15 is a port 18. Useful ion-exchange beads are the anion-exchange beads that are manufactured by Pharmacia in a size of 30 μm.

The micro-globule metering and sampling structure (b) is shown enlarged in FIG. 5B. The microchip 10 is a square which is 20 mm on each side and 5 mm thick; it is fabricated by placing two planar substrates, upper substrate 16 and lower substrate 17, in superposition and binding them together; the substrates are formed of a polymeric material such as PDMS (polydimethylsiloxane). The length of each side of the microchip, its shape and thickness are not limited to any particular values; for example, the length of each side may be set at any desired values in the range of 5-100 mm.

Microchannels are formed in the lower surface of the upper substrate 16 and in the upper surface of the lower substrate 17. The microchannels in the lower surface of the substrate 16 have a different depth (100 μm) than those in the upper surface of the substrate 17 (which are 10 μm deep). One of the characteristics of PDMS is that its surface exhibits hydrophobicity when hardened. In addition, PDMS becomes easily bondable either to itself or glass and the like upon treatment by irradiation with an O₂ plasma or an excimer laser. For these two reasons, PDMS is suitable for use in the fabrication of the micro-globule metering and sampling structure.

Depending on where in the microchip 10 the microchannels are to be formed (i.e., whether in the lower surface of the upper substrate 16 or in the upper surface of the lower substrate 17), the microchannel depth can be locally set to either the smaller or greater value which are selected as appropriate from the range of 1-200 μm.

The arrangement of the microchannels in the micro-globule metering and sampling structure (b) are shown in detail in FIGS. 5B and 5C1. Formed in the lower surface of the upper substrate 16 are the first channel 19 and the second channel 20 which are parallel to each other and extend from right to left and the third channel 21 which is connected to the first channel 19 and directed normal to the second channel 2; formed in the upper surface of the lower substrate 17 are the fourth channel 22 connecting the second channel 20 and the third channel 21 and the fifth channel 23 which branches off from the fourth channel 22 in a direction normal to it. If shallow and narrow channels are to be formed in the upper surface of the lower substrate 17, channel communication can be established by allowing them to overlap partly with the deep and wide channels formed in the lower surface of the upper substrate 16. Alternatively, as shown in FIG. 5C2, all channels may be formed in the upper substrate 16 (or in the lower substrate 17) to eliminate the need to provide partial overlap between channels. This approach of forming all channels in one substrate can be adopted by appropriately choosing the synthetic resin material for the substrate and/or by rendering more wettable or less wettable all or part of the surfaces or other necessary areas of specified channels to be formed in the substrate.

The first channel 19 and the second channel 20 have a width of 200 μm, the third channel 21 has a width of 100 μm, the fourth channel 22 has a width of 20 μm, and that part of the fifth channel 23 which is contiguous to the fourth channel 22 also has a width of 20 μm. In order to ensure that a liquid will not easily get into the fourth channel 22, it must be narrower than the first channel 19, the second channel 20 and the third channel 21; likewise, in order to ensure that a liquid will not easily get into the fifth channel 23, its thickness must be equal to or smaller than the thickness of the fourth channel 22.

The fabrication of the microchip 10 starts with the preparation of photolithographic masks. In this preliminary step, the patterns for the layouts of the microchannels to be formed in the upper substrate 16 and the lower substrate 17 are printed on separate clear films at high resolution (e.g. 4064 dpi).

In the next step, a silicon (Si) wafer is diced with a diamond cutter to the dimensions of the microchip to be fabricated. The blank is then washed by sonication, dried and subjected to an O₂ plasma treatment in a plasma reactor at 200 W for 30 seconds.

Then, the blank is spin coated with a negative-acting photoresist SU-8 50 or SU-8 (if 100-μm channels are to be formed, SU-8 50 is applied at 2000 rpm for 10 seconds; if 10-μm channels are to be formed, SU-8 is applied at 2000 rpm for 10 seconds) and allowed to stand in an oven at 90° C. for 30 minutes.

Then, using a mask aligner, the patterns (printed on films) for the layouts of the microchannels to be formed in the upper substrate 16 and the lower substrate 17 of the microchip 10 are transferred to the separate SU-8 or S8 50 coated silicon wafers by photolithography. After standing in an oven at 90° C. for 30 minutes, the wafers are dipped in a developer (e.g. 1-methoxy-2-propyl acetate), washed successively with isopropyl alcohol and distilled water, and dried.

The thus prepared masters have embossed structures and can be used as templates for the microchannels to be formed in the upper substrate 16 and the lower substrate 17.

In order to facilitate the removal of PDMS replicas after molding, the masters are surface treated by being allowed to stand in a 3% dimethyloctadecylchlorosilane/toluene solution for 2 hours before pouring in a PDMS prepolymer.

Then, a 10:1 mixture of a PDMS prepolymer and a curing reagent (e.g. Sylgard 184 of Dow Corning Co., MI) is well agitated, poured into polyacrylic frames holding the masters, and cured by standing at 90° C. for 30 minutes.

After curing, the PDMS replicas are detached from the masters, leaving the upper substrate 16 and the lower substrate 17 of the microchip 10 behind. The lower surface of the upper substrate 16 and the upper surface of the lower substrate 17 are treated with an O₂ plasma and bonded together to form the microchip 10.

Using the thus fabricated microchip 10, one can meter and sample very small amounts of globules as follows in the actual practice of sample injection.

To begin with, a sample is introduced into the first channel 19 at an end under the action of a pressure flow until it fills the first channel 19 and the third channel 21. The sample will not get into the fourth channel 22 since it has a property of being less wettable or insensitive to capillary attraction and is sufficiently narrower than the first channel 19, the second channel 20 and the third channel 21 that it does not easily wet with a hydrophilic liquid.

If the second channel 20 is filled with a liquid in the absence of the fifth channel 23, air in the third channel 21 will leak into the second channel 20 as the sample is introduced into the third channel 21.

In fact, however, the micro-globule metering and sampling structure (b) has the fifth channel 23, so even if the second channel 20 is filled with a liquid, air in the third channel 21 will escape into the fifth channel 23 and the sample can be smoothly introduced into the third channel 21 without causing air to leak into the second channel 20.

Subsequently, air is introduced into the first channel 19 under the action of a pressure flow, whereupon the sample is pushed out of the first channel 19 and only remains in the third channel 21. The sample in the third channel 21 will not flow back into the first channel 19. The microchip under consideration is so designed that 5 nL of sample will remain in the third channel 21.

Subsequently, the pressure in the first channel 19 is increased, whereupon the sample in the third channel 21 leaks into the fourth channel 22 and thence flows into the second channel 20. Since the exit of the fifth channel 23 is closed, there will be no leakage of the sample into the fifth channel 23 and it is effectively introduced into the second channel 20.

In order to lower the possibility of the sample to leak into the fifth channel 23, the width of the fifth channel is desirably equal to or smaller than the width of the fourth channel 22. In the case under consideration, the fourth channel 22 and the fifth channel 23 are both set to a width of 20 μm.

In order to ensure that the sample (e.g. protein) to be separated by chromatography will not adsorb to PDMS, the wall surfaces of the first channel 19, the second channel 20 and the third channel 21 are rendered hydrophilic by treatment with HCl. The method of providing hydrophilic surfaces is not limited to the treatment with HCl and the same result can be attained by using an O₂ plasma or albumin. PDMS itself is a hydrophobic substance.

Chromatography was actually done performing sample injection by the above-described micro-globule metering and sampling procedure: a solution of a mixture of FITC-labelled albumin and IgG was introduced as a sample while Tris/HCl buffer (pH 8.0) was flowed at a rate of 1.0 μL/min to effect adsorption on anion-exchange beads (product of Pharmacia; bead size, 30 μm); by using a 0-1 M gradient of NaCl buffer, albumin and IgG could be separated within one minute.

In Example 1, the micro-globule metering and sampling structure was fabricated of PDMS. This is not the sole case of the invention and the structure is compatible with a wide variety of materials (e.g. silicon, polymers, glass, ceramics and metals) if the wettability of the interior of channels can be adjusted by rendering part or all of their surfaces and/or end faces either more wettable or less wettable. The structure can also be fabricated by using composites of the above-mentioned materials or mixing them with suitable substances such as a temperature- and pH-responsive PIPAAm (N-isopropylacrylamide).

### EXAMPLE 2

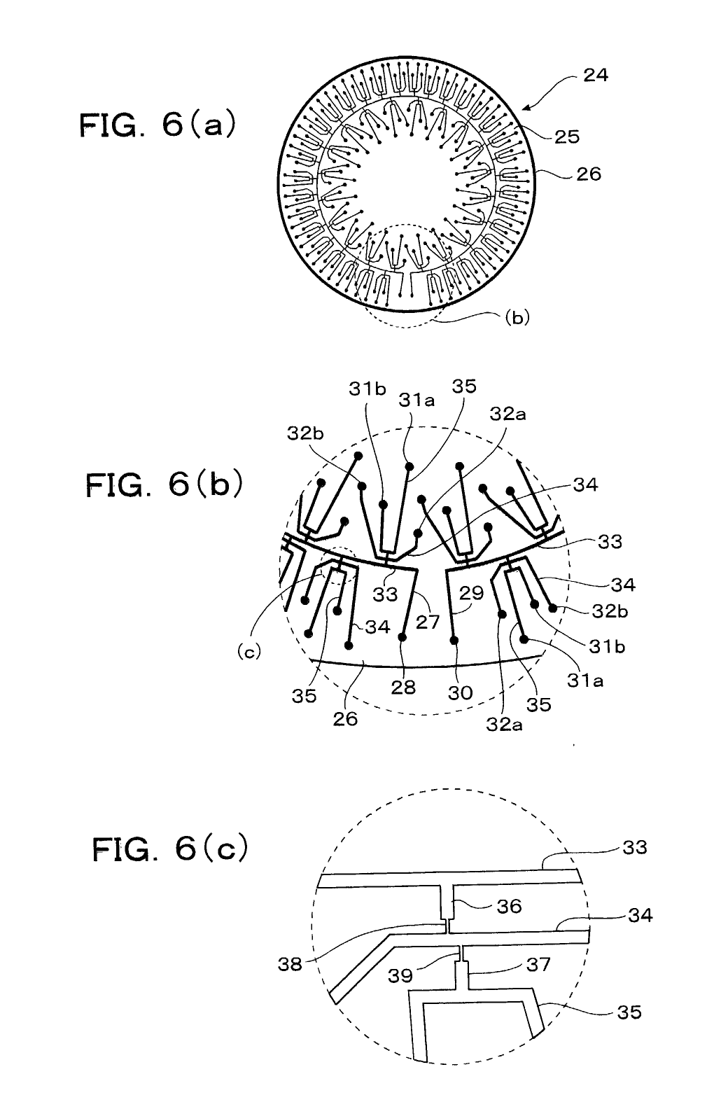

FIG. 6A is a plan view of a microchip employing the micro-globule metering and sampling structure according to another example of the invention. The microchip generally indicated by 24 in FIG. 6A is capable of carrying out up to 50 kinds of reaction or analysis individually by mixing two quantitatively metered and sampled liquids. It adopts the micro-globule metering and sampling structure in the globule metering and sampling portion. The microchip 24 shown in FIG. 6A is capable of carrying out up to 50 kinds of reaction or analysis. Of course, microchips capable of carrying out a greater number of reactions or analyses can be fabricated.

Using the microchip 24 shown in FIG. 6A, one can mix a single reagent with up to 50 kinds of sample and carry out reactions or analyses individually and simultaneously by an extremely simple procedure. Alternatively, one can mix a single sample with up to 50 kinds of reagent and carry out reactions or analyses individually and simultaneously.

As in the case of the microchip 10 shown in FIG. 5, the microchip 24 shown in FIG. 6A can be fabricated by placing two planar substrates in superposition and binding them together. The substrates are formed of a polymeric material such as PDMS (polydimethylsiloxane). The microchip 24 is a disk 90 mm across and 3 mm thick. Other values of diameter and thickness can of course be employed. The shape of the microchip 24 is not limited to a disk and it can be formed from rectangular or polygonal substrates.

Speaking further of the microchip 24 shown in FIG. 6A, microchannels are formed in the lower surface of the upper substrate 25 and in the upper surface of the lower substrate 26. The microchannels in the lower surface of the substrate 25 have a different depth (say, 100 μm) than those in the upper surface of the substrate 26 (which may be 10 μm deep). Other values of thickness can of course be adopted.

FIG. 6B is an enlarged view of area (b) of the microchip 24 shown in FIG. 6A, and FIG. 6C is an enlarged view of area (c) shown in FIG. 6B.

As shown in FIG. 6B, the first liquid supply channel 33 which is in the center of the microchip 24 and is generally of a ring shape has one interruption; one end of the interruption connects to and communicates with a port 28 via a channel 27 that extends radially outward and the other end connects to and communicates with a port 30 via a channel 29 that also extends radially outward. Port 28 is an inlet for the first liquid to be mixed and port 30 is an outlet for the same liquid. The liquid introduced at the port 28 flows into the first liquid supply channel 33 via channel 27 and, after flowing through the first liquid supply channel 33, comes out of the port 30 via channel 29. Alternatively, port 28 may be used as an outlet for the first liquid and port 30 as an inlet.

Further referring to FIG. 6B, a port 31a is an inlet for the second liquid to be mixed and communicates with an exit port 31b via the second liquid supply channel 35. Since the inlet port 31a communicates with the exit port 31b via the second liquid supply channel 35, a liquid injected from the inlet port 31a can easily fill the second liquid supply channel 35 by suitable means such as pneumatic pressure. Port 31a communicates with an adjacent port 32a via a mixing channel 34 and port 31b communicates with an adjacent port 32b via the same mixing channel 34. The mixing channel 34 also functions as a chamber in which two mixed globules react with each other. Since the ports 32a and 32b communicate with each other via the mixing channel 34, pneumatic pressure may be applied into the mixing channel 34 via the port 32a and/or port 32b so as to promote the mixing of globules in the channel or recover the reaction product out of the channel.

Provided radially outward of the first liquid supply channel 33 are thirty structures for metering, sampling and mixing micro-globules, each consisting of ports 31a, 31b and the second liquid supply channel 35, as well as ports 32a, 32b and the mixing channel 34. Twenty similar structures for metering, sampling and mixing micro-globules are provided radially inward of the first liquid supply channel 33. The number of the structures for metering, sampling and mixing micro-globules that can be provided is in no way limited to the illustrated embodiment.

The structure shown in FIG. 6C is fabricated for the same purpose as the structure shown in FIG. 2B and it consists of a microchannel structure for metering and sampling two micro-globules and a channel for mixing them. As shown, a first liquid supply channel 33 for supplying one liquid (which corresponds to channel A in FIG. 2B) and a second liquid supply channel 35 for supplying the other liquid (which corresponds to channel A′ in FIG. 2B) are provided on opposite sides of a mixing channel 34 which functions as a reaction chamber (corresponding to channel B in FIG. 2B). One liquid being supplied from the first liquid supply channel 33 is metered and sampled in a given quantity by means of a first metering and sampling channel 36 (corresponding to channel C in FIG. 2B). Similarly, the other liquid being supplied from the second liquid supply channel 35 is metered and sampled in a given quantity by means of a second metering and sampling channel 37 (corresponding to channel C′ in FIG. 2B). By common means such as pressure difference, the globules in the channels 36 and 37 are passed through a first narrower channel 38 and a second narrower channel 39, respectively, and introduced into the mixing channel 34, where they are mixed together.

Further referring to FIG. 6, the first liquid supply channel 33 for supplying one liquid, the second liquid supply channel 35 for supplying the other liquid and the mixing channel 34 may each have a width of 200 μm; the first metering and sampling channel 36 and the second metering and sampling channel 37 may each have a width of 100 μm and a length of 600 μm; the first narrower channel 38 and the second narrower channel 39 may each have a width of 20 μm. Other values of channel width and length may of course be employed. Referring to FIG. 6C, the two liquids to be mixed each weigh 6 nL and this volume is equal to the capacity of the first metering and sampling channel 36 and the second metering and sampling channel 37. Hence, by changing the capacity of these channels, the volume of the two liquids to be mixed is freely adjustable within the range of 1 μL to 1 μL.

The microchip 24 shown in FIG. 6 can be fabricated by the same process as what is employed to manufacture the microchip 10 shown in FIG. 5.

One application of the microchip 24 shown in FIG. 6 is in metering, sampling and mixing micro-globules for the purpose of performing quantitative analysis of glucose by the glucose oxidase/peroxidase method.

To perform metering, sampling and mixing micro-globules for the purpose of performing quantitative analysis of glucose by the glucose oxidase/peroxidase method, the following procedure is taken. In the glucose oxidase/peroxidase method, a phosphate buffer containing a mixture of glucose oxidase, peroxidase, mutarotase, 4-aminoantipyrine and phenol in suitable amounts is used as a reagent and an aqueous glucose solution is used as a sample.

First, about 1 μL of the reagent is introduced in a direction from port 28 toward port 30 (FIG. 6A) under the action of pressure flow and thereafter air is introduced in order to displace the superfluous reagent. The introduced reagent and air flow clockwise through the first liquid supply channel 33. Referring to FIG. 6C, the first narrower channel 38 is hydrophobic and less wettable with a liquid and it has a smaller width than the first liquid supply channel 33 and the first metering and sampling channel 36; hence, the reagent introduced into the first metering and sampling channel 36 is retained in that channel and will not get into the first narrower channel 38.

As a result, a globule of the reagent can be metered and sampled within the first metering and sampling channel 36 in a volume which is equal to the capacity of that channel As a further advantage, the introduction of the reagent in a direction from port 28 toward port 30 and the subsequent air introduction need to be performed only once to ensure that globules of the reagent in predetermined amounts are metered and sampled in a single step within the 50 first metering and sampling channels 36. By means of this very simple procedure, a micro-globule is further divided and a great number of droplets can be formed simultaneously in much smaller quantities. It is also anticipated that only an extremely small amount of the liquid will remain undistributed at the end of the procedure.

Subsequently, as in the case of the reagent, the sample is introduced in a direction from port 31a toward port 31b and a globule of the sample can be metered and sampled in a predetermined amount within the second metering and sampling channel 37 via the second liquid supply channel 35.

In the next step, the pneumatic pressure within the first liquid supply channel 33 and the second liquid supply channel 35 is elevated, whereupon the reagent in the first metering and sampling channel 36 and the sample in the second metering and sampling channel 37 are pushed into the mixing channel 34, where they are mixed together. The resulting mixture reddens through chemical reaction and by evaluating the hue of the red color, quantitative analysis of glucose can be accomplished. Needless to say, the microchip 24 shown in FIG. 6 can also be used in other qualitative and/or quantitative analyses.

As described above, the present invention provides a micro-globule metering and sampling structure which is simple in structure and requires only simple procedures to achieve quantitative metering and sampling of very small amounts of globules. The invention also provides a micro-globule metering and sampling structure which, when used in a variety of apparatuses that require quantitative handling of globules, can reduce the dead volume of the sample while saving the installation space and cost of the overall apparatus.

What is claimed is:

1. A micro-globule metering and sampling structure having a first channel and a second channel that extend in specified directions, a third channel open to a wall of said first channel and a fourth channel that is open to a wall of said second channel such that it couples an end of said third channel to said second channel, that has a property of being less wettable (or insensitive to capillary attraction) and that is narrower than the other three channels, wherein a liquid introduced into said first channel is drawn into said third channel via the opening of said third channel which is open in a wall of said first channel and thereafter said liquid that remains in said first channel is removed to meter and sample a volume of globule equal to the capacity of said third channel.

2. A micro-globule metering and sampling structure having at least two systems each having a first channel and a second channel that extend in specified directions, a third channel open to a wall of said first channel and a fourth channel that is open to a wall of said second channel such that it couples an end of said third channel to said second channel, that has a property of being less wettable (or insensitive to capillary attraction) and that is narrower than the other three channels, wherein a liquid introduced into said first channel is drawn into said third channel via the opening of said third channel which is open in a wall of said first channel and thereafter said liquid that remains in said first channel is removed to meter and sample a volume of globule equal to the capacity of said third channel, said at least two systems sharing said first channel or said second channel.

3. The micro-globule metering and sampling structure according to claim 1 or 2, wherein two or more of said fourth channels are connected to said third channel or, alternatively, said fourth channel has two or more branches.

4. The micro-globule metering and sampling structure according to any one of claims 1-3, which has more than one set of said third channel and the fourth channel connected to it.

5. The micro-globule metering and sampling structure according to any one of claims 1-4, which further has a fifth channel that is open to a wall of said fourth channel, that is narrower than or equal in thickness to said fourth channel and that is made of a wall having a property of being less wettable (or insensitive to capillary attraction).

6. The micro-globule metering and sampling structure according to any one of claims 1-5, which further has means by which the globule that has been metered and sampled in a volume equal to the capacity of said third channel is allowed to flow into said second channel via said fourth channel.

7. The micro-globule metering and sampling structure according to claim 6, which further has means by which the globule that has been metered and sampled in a volume equal to the capacity of said third channel is allowed to flow into said second channel via said fourth channel when said second channel is filled with a liquid up to the area which is near the opening of said fourth channel.

8. The micro-globule metering and sampling structure according to any one of claims 1-7, wherein said first channel, said second channel, said third channel, said fourth channel and said fifth channel are each formed in a substrate.

9. The micro-globule metering and sampling structure according to any one of claims 1-8, wherein said third channel is designed to have a capacity ranging from the picoliter to microliter order.

10. A microchip having at least one unit of the micro-globule metering and sampling structure according to any one of claims 1-9 in a substrate.

11. The microchip according to claim 10, which has more than one unit of the micro-globule metering and sampling structure according to any one of claims 1-9 in a substrate.

12. The microchip according to claim 10 or 11, wherein said substrate has a dual structure consisting of an upper substrate joined to a lower substrate.

13. A microchip for use in capillary ion-exchange chromatography, which comprises a substrate having a dual structure consisting of an upper substrate joined to a lower substrate, said substrate having an ion-exchange chromatographic microchannel formed in it, eluting buffer introducing ports and a mixer communicating with said ports being connected to said microchannel at a point on its length, a micro-globule metering and sampling structure being provided in said microchannel between an ion-exchange beads blockage and the joint to said mixer, said micro-globule metering and sampling structure comprising a first channel, a second channel which constitutes said microchannel, a third channel for metering and sampling a globule which is open to a wall of said first channel, a fourth channel that communicates with said third channel and said second channel, that is narrower than said first, second and third channels and that has a property of being less wettable (or insensitive to capillary attraction), and a fifth channel that crosses said fourth channel and which is generally as wide as or narrower than said fourth channel.

14. The microchip according to claim 13, wherein said upper substrate and said lower substrate are each made of polydimethylsiloxane (PDMS) and the surface of said lower substrate has been rendered hydrophobic by hardening.

15. A microchip for use in submicron analysis and synthesis or separation, which comprises a substrate having a dual structure consisting of an upper substrate joined to a lower substrate, said substrate having a generally ring-shaped first liquid supply channel formed in it with a liquid inlet port at one end and a liquid outlet port at the other end, said first liquid supply channel having a plurality of first metering and sampling channels that are open to its wall, each of said first metering and sampling channels accompanying a single set of a mixing channel and a second liquid supply channel, said first metering and sampling channel communicating with said mixing channel via a first narrower channel having a property of being less wettable (or insensitive to capillary attraction), said second liquid supply channel having a single second metering and sampling channel that is open to its wall, said second metering and sampling channel communicating with said mixing channel via a second narrower channel also having a property of being less wettable (or insensitive to capillary attraction), said second liquid supply channel and said mixing channel having inlet ports and outlet ports, respectively, each of said ports being formed through said upper substrate.

16. The microchip according to claim 15, wherein said substrate is disk-shaped and 20 sets of said first metering and sampling channel, said first narrower channel, said mixing channel, said second narrower channel, said second metering and sampling channel and said second liquid supply channel are provided radially inward of said generally ring-shaped first liquid supply channel whereas 30 sets of said first metering and sampling channel, said first narrower channel, said mixing channel, said second narrower channel, said second metering and sampling channel and said second liquid supply channel are provided radially outward of said generally ring-shaped first liquid supply channel.

17. The microchip according to claim 15 or 16, wherein said upper substrate and said lower substrate are each made of polydimethylsiloxane (PDMS) and the surface of said lower substrate has been rendered hydrophobic by hardening.
